(19) United States
(12) Patent Application Publication
(10) Pub. No.: US 2003/0041276 A1
(43) Pub. Date: Feb. 27, 2003

(54) Semiconductor device allowing control of clock supply to processor on a clock cycle basis

(75) Inventor: Masayuki Koyama, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/197,578

(22) Filed: Jul. 18, 2002

(30) Foreign Application Priority Data
Aug. 21, 2001 (JP) 2001-250286(P)

(51) Int. Cl. G06F 1/04

(52) U.S. Cl. 713/400

(57) ABSTRACT

The semiconductor device includes a processor and an interface. In the interface, an interface circuit outputs a bus-use request signal in response to an access request to a system bus from the processor, and receives a bus-use permit signal. An activation signal generating circuit generates an enable signal that is at an L level from the output of the bus-use request signal to the reception of the bus-use permit signal and attains an H level after the reception of the bus-use permit signal. An AND gate performs an AND operation of the enable signal and a latch signal, and outputs an intermittent clock to a flip-flop of the processor. Thus, the clock supply to the processor can be controlled on a clock cycle basis during a bus master period.

### BACKGROUND OF THE INVENTION

1. Field of the Invention

The present invention relates to a semiconductor device including a processor that receives data via a system bus and processes the data in synchronization with a clock, particularly to the one allowing reduction of power consumption.

2. Description of the Background Art

Referring to FIG. 14, a semiconductor device 300 performing data processing in synchronization with a clock includes: a processor 310, an interface 320, a PLL (Phase Locked Loop) circuit 330, a system bus 340, and an arbiter 350. Interface 320 includes a clock control register 321.

Processor 310 sends/receives an access signal ACES to/from interface 320, and receives data DA and a clock CLK from interface 320. Processor 310 performs various kinds of data processing in synchronization with clock CLK. Interface 320 controls transmission of the data or the like between processor 310 and system bus 340. Clock control register 321 included in interface 320 receives clock CLK from PLL circuit 330 via system bus 340, and controls application of the received clock CLK to processor 310. Here, clock control register 321 uses software to control the clock application to processor 310.

PLL circuit 330 multiplies the frequency of a base clock CLKO input from the outside of semiconductor device 300 to generate clock CLK, and outputs the generated clock CLK to system bus 340. System bus 340 transmits data and signals output from respective portions of semiconductor device 300.

Arbiter 350 receives a request signal (hereinafter, “bus-use request signal”) BSAK for use of system bus 340 from interface 320, and determines availability of system bus 340. When system bus 340 is available, arbiter 350 outputs a permit signal (hereinafter, “bus-use permit signal”) BSAW for the use of system bus 340 to interface 320 via system bus 340.

When processor 310 wants to access system bus 340 for data processing, interface 320 receives access signal ACES from processor 310 and, in response, outputs bus-use request signal BSAK of system bus 340 to arbiter 350 via system bus 340. Upon receipt of bus-use request signal BSAK, arbiter 350 determines availability of system bus 340 and, when system bus 340 is available, outputs bus-use permit signal BSAW of system bus 340 to interface 320 via system bus 340. Interface 320 receives bus-use permit signal BSAW, and outputs to processor 310 access signal ACES indicating that system bus 340 is available. Receiving this access signal ACES, processor 310 accesses system bus 340 to perform the data processing.

This means that there exists a certain amount of wait time from when processor 310 outputs access signal ACES to interface 320 in an attempt to start data processing until it actually starts the data processing.

Furthermore, processor 310 operates in synchronization with clock CLK of, e.g., 300 MHz. When it sends data to and receives data from an external memory placed outside of semiconductor device 300 operating in synchronization with a clock of 15 MHz, processor 310 operates once every 20 cycles of clock CLK. This means that there exists a time period in which processor 310 does not operate in fact.

In a conventional semiconductor device, a clock has been supplied to a processor under the control of software, which cannot control start/stop of the clock supply to the processor dynamically. As a result, there has been a problem that the clock is supplied to the processor even when it is not operating, so that power consumption of the semiconductor device increases.

As a way of reducing power consumption of a semiconductor device, Japanese Patent Laying-Open No. 8-083133 discloses a computer system in which clock supply to a processor is stopped when the processor is in a non-operational state.

The computer system disclosed therein, however, does not control the clock supply to the processor during a bus master period. In addition, it is not clearly disclosed in the reference whether the clock supply to the processor can be controlled on a clock cycle basis.

As such, with a conventional semiconductor device, it was impossible to control clock supply to a processor during a bus master period in a unit of clock cycle.

### SUMMARY OF THE INVENTION

Based on the foregoing, an object of the present invention is to provide a semiconductor device that can control clock supply to a processor during a bus master period on a clock cycle basis.

According to an aspect of the present invention, the semiconductor device performing data processing in synchronization with a clock includes: a processing circuit reading the data from a system bus in response to an operation command and performing the data processing in synchronization with the clock; an interface circuit controlling signal and data transmission between the system bus and the processing circuit; and a clock supply circuit providing the clock to the processing circuit, the clock supply circuit stopping provision of the clock to the processing circuit on a clock cycle basis when the interface circuit determines that the processing circuit has entered a waiting state for access to the system bus.

In this semiconductor device, the processing circuit waits for access to the system bus for a prescribed period of time to acquire data necessary for data processing. The interface circuit detects a waiting state of the processing circuit in which it waits for the access to the system bus. When the interface circuit detects this access-waiting state of the processing circuit, the clock supply circuit stops clock supply to the processing circuit on a clock cycle basis. Accordingly, power consumption in the semiconductor device is reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram of the semiconductor device according to a first embodiment of the present invention.

FIG. 2 illustrates signals and others transmitted between the system bus and the interface, and between the interface and the processor shown in FIG. 1.

FIG. 3 is a schematic block diagram of the interface and the processor shown in FIG. 2.

FIG. 4 is a circuit diagram of the activation signal generating circuit shown in FIG. 3.

FIGS. 5-8 are timing charts of signals illustrating operations of the interface and the processor shown in FIG. 1.

FIG. 9 is a schematic block diagram of the semiconductor device according to a second embodiment of the present invention.

FIG. 10 is a schematic block diagram of the interface and the processor shown in FIG. 9.

FIG. 11 is a schematic block diagram of the semiconductor device according to a third embodiment of the present invention.

FIG. 12 is a schematic block diagram of the interface and the processor shown in FIG. 11.

FIG. 13 is a schematic block diagram of the semiconductor device according to a fourth embodiment of the present invention.

FIG. 14 is a schematic block diagram of a conventional semiconductor device.

### DESCRIPTION OF THE PREFERRED EMBODIMENTS

Hereinafter, embodiments of the present invention will be described in detail with reference to the drawings, through which the same or corresponding portions are denoted by the same reference character, and description thereof is not repeated where appropriate.

First Embodiment

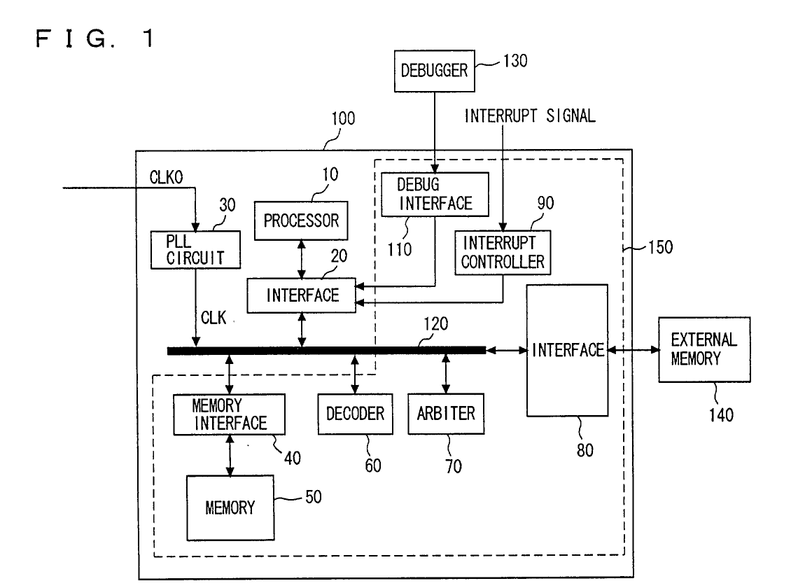

Referring to FIG. 1, the semiconductor device 100 according to the first embodiment includes a processor 10, interfaces 20, 80, a PLL circuit 30, a memory interface 40, a memory 50, a decoder 60, an arbiter 70, an interrupt controller 90, a debug interface 110, and a system bus 120.

Processor 10 consists of a central processing unit (CPU) or a digital signal processor (DSP), which performs various kinds of data processing in synchronization with a clock (an intermittent clock GCLK, which will be described later) provided from interface 20. Interface 20 controls transmission of data and others between processor 10 and system bus 120. During a time period in which processor 10 is not in operation, interface 20 stops clock supply to processor 10 on a clock cycle basis, in a manner that will be described later.

PLL circuit 30 multiplies the frequency of a reference clock CLKO supplied from the outside of semiconductor device 100 to generate a clock CLK, and outputs the generated clock CLK to system bus 120. Memory interface 40 controls transmission of data and others between memory 50 and system bus 120.

Memory 50 is formed of any of dynamic random access memory (DRAM), static random access memory (SRAM) and flash memory, and stores data. Decoder 60 decodes an address for data reading/writing with respect to memory 50 and an external memory 140.

Arbiter 70 receives a bus-use request signal of system bus 120 from interface 20 via system bus 120, and determines availability of system bus 120. When system bus 120 is available, arbiter 70 outputs a bus-use permit signal to interface 20 via system bus 120.

Interface 80 controls transmission of data between system bus 120 and external memory 140.

Interrupt controller 90 receives an interrupt signal input from the outside of semiconductor device 100, and outputs the received interrupt signal to interface 20. Debug interface 110 receives a debug start signal from a debugger 130 placed outside of semiconductor device 100, and outputs the received debug start signal to interface 20.

In semiconductor device 100, memory interface 40, memory 50, decoder 60, arbiter 70, interface 80, interrupt controller 90 and debug interface 110 constitute a slave portion 150.

Debugger 130 outputs the debug start signal for debugging a program executed on processor 10 to debug interface 110. External memory 140 is formed of any of DRAM, SRAM and flash memory, and stores data and others.

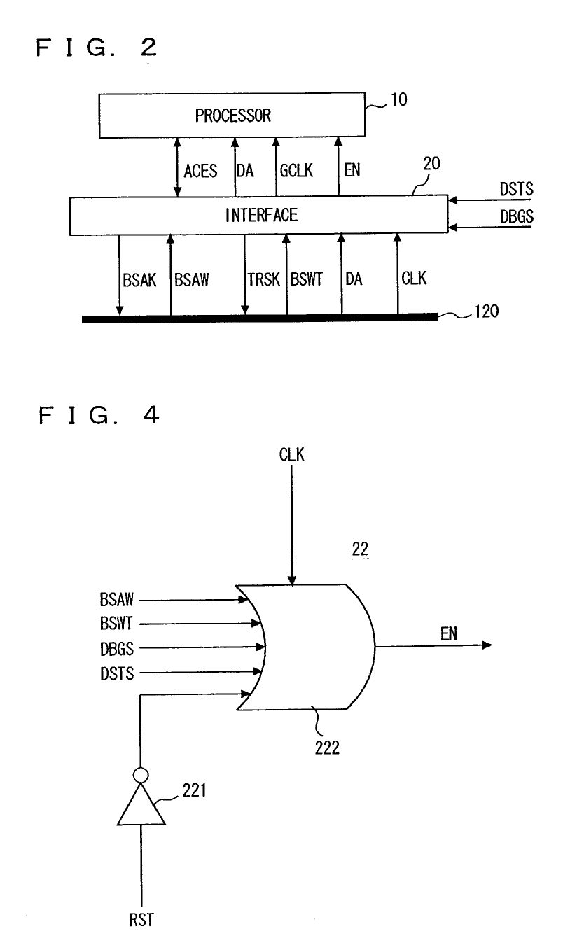

Referring to FIG. 2, signal and data transmission between processor 10, interface 20, and system bus 120 will be described. Processor 10 sends/receives an access signal ACES to/from interface 20. Access signal ACES includes: a system bus access request that processor 10 outputs to interface 20 for accessing system bus 120; a read/write request that processor 10 outputs to interface 20 for writing data to or reading data from memory 50 (or external memory 140); a system bus use permission that interface 20 outputs to inform processor 10 that the use of system bus 120 is permitted; and a read/write permission that interface 20 outputs to inform processor 10 that the data writing/reading with respect to memory 50 (or external memory 140) is permitted.

Upon receipt of the system bus access request from processor 10, interface 20 outputs a bus-use request signal BSAK requesting the use of system bus 120 to arbiter 70 via system bus 120. When interface 20 receives a bus-use permit signal BSAW from arbiter 70, it outputs access signal ACES, i.e., the system bus use permission, to processor 10.

Upon receipt of the read/write request from processor 10, interface 20 outputs a transaction signal TRSK for performing the data writing/reading with respect to memory 50 (or external memory 140) to memory interface 40 (or interface 80) via system bus 120. In response, interface 20 receives a bus-wait signal BSWT from memory interface 40 (or interface 80). Here, memory interface 40 (or interface 80) outputs bus-wait signal BSWT of an L (logical low) level until the access to memory 50 (or external memory 140) is permitted, and outputs bus-wait signal BSWT of an H (logical high) level once the access to memory 50 (or external memory 140) is permitted. Thus, upon receipt of bus-wait signal BSWT of an H level from memory interface 40 (or interface 80), interface 20 outputs access signal ACES, i.e., the read/write permission, to processor 10.

Further, interface 20 receives data from memory 50 (or external memory 140) via system bus 120, and outputs the received data to processor 10.

Still further, interface 20 receives interrupt signal DSTS and debug start signal DBGS from interrupt controller 90 and debug interface 110, respectively. Interface 20 generates an enable signal EN based on bus-use permit signal BSAW, bus-wait signal BSWT, interrupt signal DSTS and debug start signal DBGS in a manner that will be described later, and outputs the generated enable signal EN to processor 10.

Interface 20 further receives clock CLK from PLL circuit 30 via system bus 120, and generates an intermittent clock GCLK. This intermittent clock GCLK is generated by deleting from clock CLK one or more clock components (hereinafter, collectively referred to as the “clock component”) corresponding to a time period in which processor 10 is in a non-operational state. Interface 20 outputs the generated intermittent clock GCLK to processor 10.

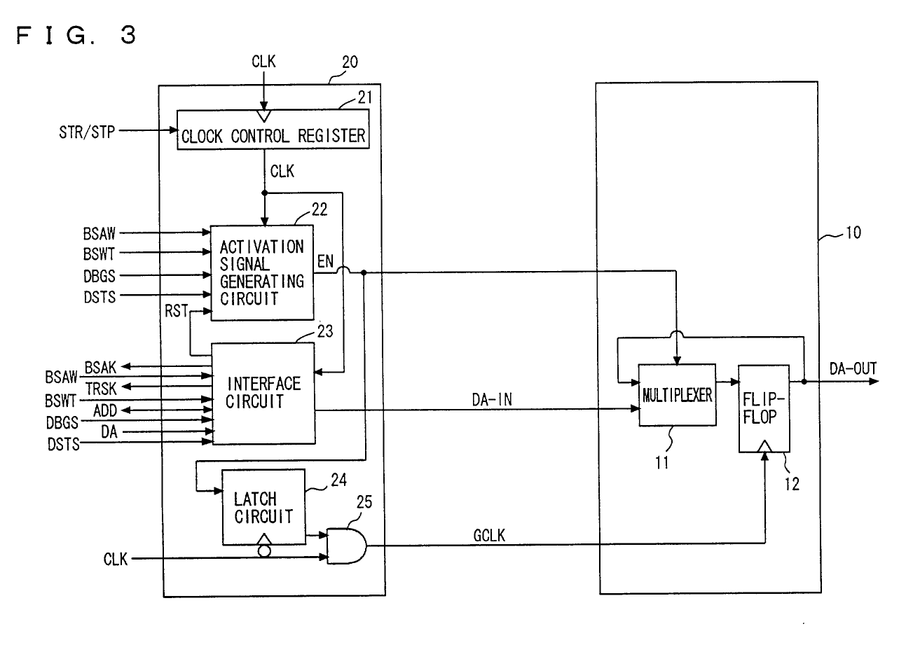

Referring to FIG. 3, interface 20 includes a clock control register 21, an activation signal generating circuit 22, an interface circuit 23, a latch circuit 24, and an AND gate 25.

Clock control register 21 is started/stopped in response to start/stop signals STR/STP, respectively, input from the outside of semiconductor device 100. When started by start signal STR, clock control register 21 provides clock CLK, input via system bus 120, to activation signal generating circuit 22 and interface circuit 23. When stopped by stop signal STP, clock control register 21 stops the supply of clock CLK to activation signal generating circuit 22 and interface circuit 23. Clock control register 21 uses software for the control of clock supply.

Activation signal generating circuit 22 generates enable signal EN based on bus-use permit signal BSAW and bus-wait signal BSWT received via system bus 120, debug start signal DBGS received from debug interface 110, interrupt signal DSTS received from interrupt controller 90, and a reset signal RST received from interface circuit 23, and outputs the generated enable signal EN to processor 10 and latch circuit 24.

Upon receipt of the system bus access request from processor 10, interface circuit 23 outputs bus-use request signal BSAK to arbiter 70 via system bus 120. In response, it receives bus-use permit signal BSAW from arbiter 70 via system bus 120. Upon receipt of the read/write request for the data reading/writing with respect to memory 50 (or external memory 140) from processor 10, interface circuit 23 outputs transaction signal TRSK to memory interface 40 (or interface 80) via system bus 120. In response, it receives bus-wait signal BSWT from memory interface 40 (or interface 80) via system bus 120. Interface circuit 23 also receives debug start signal DBGS from debug interface 110 and interrupt signal DSTS from interrupt controller 90, and further transmits an address ADD to/from system bus 120. Interface circuit 23 also receives data DA from system bus 120, and outputs the received data DA as input data DA-IN to processor 10 in synchronization with clock CLK.

Latch circuit 24 latches enable signal EN in synchronization with an inverse clock of clock CLK input via system bus 120, and outputs a latch signal ENLTH of enable signal EN to AND gate 25.

AND gate 25 performs an AND operation between latch signal ENLTH and clock CLK to generate intermittent clock GCLK, and outputs the generated intermittent clock GCLK to processor 10.

Processor 10 includes a multiplexer 11 and a flip-flop 12. Of the components included in processor 10, only those concerning the control of data updating are shown in FIG. 3. Multiplexer 11 receives input data DA-IN from interface circuit 23 and output data DA-OUT of flip-flop 12. When enable signal EN of an H level is input from activation signal generating circuit 22, multiplexer 11 selects and outputs the input data DA-IN to flipflop 12. Upon receipt of enable signal EN of an L level from activation signal generating circuit 22, it selects and outputs the output data DA-OUT to flip-flop 12. Thus, enable signal EN is used in multiplexer 11 of processor 10 as a select signal for selecting either one of input data DA-IN and output data DA-OUT.

Flip-flop 12 operates in synchronization with intermittent clock GCLK from AND gate 25. It delays the data output from multiplexer 11 by one clock cycle of intermittent clock GCLK, and outputs it as output data DA-OUT. Thus, it is possible, using multiplexer 11 and flip-flop 12, to control whether to update data or not.

Referring to FIG. 4, activation signal generating circuit 22 includes an inverter 221 and an OR gate 222. Inverter 221 inverts reset signal RST from interface circuit 23, and outputs the inverted signal to OR gate 222. OR gate 222 performs an OR operation of bus-use permit signal BSAW, bus-wait signal BSWT, debug start signal DBGS, interrupt signal DSTS and inverse signal /RST of reset signal RST in synchronization with clock CLK, and outputs the operation result as enable signal EN to latch circuit 24 and multiplexer 11 of processor 10. Since enable signal EN is used as the select signal for data selection in multiplexer 11 as described above, OR gate 222 substantially constitutes a “select signal generating circuit”.

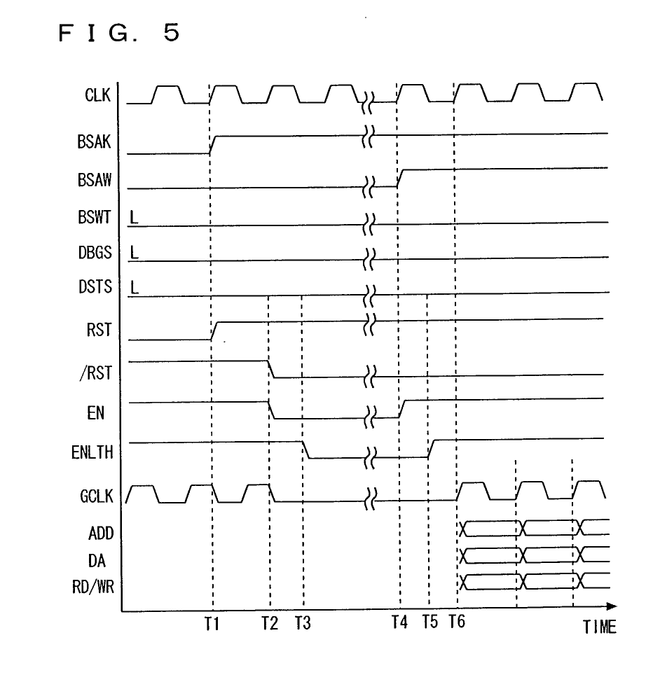

Referring to FIG. 5, the operation for processor 10 to acquire the access right to system bus 120 will be described. Processor 10 outputs a system bus access request to interface circuit 23 for accessing system bus 120. In response to this request from processor 10, interface circuit 23 outputs bus-use request signal BSAK to arbiter 70 via system bus 120. More specifically, interface circuit 23 outputs bus-use request signal BSAK that switches from an L level to an H level at timing T1. Interface circuit 23 also outputs reset signal RST having the same logical level as bus-use request signal BSAK to activation signal generating circuit 22.

When reset signal RST is input, inverter 221 of activation signal generating circuit 22 inverts reset signal RST, while delaying it by one clock cycle of clock CLK, and outputs the inverted signal/RST to OR gate 222. That is, inverter 221 outputs inverse signal/RST that switches from an H level to an L level at timing T2, to OR gate 222. In this case, OR gate 222 receives bus-use permit signal BSAW of an L level, bus-wait signal BSWT of an L level, debug start signal DBGS of an L level, and interrupt signal DSTS of an L level.

When bus-use request signal BSAK is input via system bus 120, arbiter 70 determines availability of system bus 120. When system bus 120 is available, it outputs bus-use permit signal BSAW via system bus 120 to activation signal generating circuit 22 and interface circuit 23 in interface 20. More specifically, arbiter 70 outputs bus-use permit signal BSAW that switches from an L level to an H level at timing T4.

In response, OR gate 222 outputs, to multiplexer 11 and latch circuit 24, enable signal EN that switches from an H level to an L level at timing T2 and switches from an L level to an H level at timing T4, based on bus-use permit signal BSAW, bus-wait signal BSWT, debug start signal DBGS, interrupt signal DSTS and inverse signal/RST.

Latch circuit 24 receives enable signal EN from activation signal generating circuit 22, and outputs latch signal ENLTH corresponding to the enable signal EN latched by a half cycle of clock CLK, to AND gate 25. AND gate 25 performs an AND operation of latch signal ENLTH and clock CLK to generate intermittent clock GCLK, and outputs the generated intermittent clock GCLK to flip-flop 12. This intermittent clock GCLK is the clock from which the clock component corresponding to the time period from timing T3 to timing T6 has been deleted.

When bus-use permit signal BSAW of an H level permitting the use of system bus 120 is input, interface circuit 23 outputs to processor 10 the access signal ACES consisting of the system bus use permission indicating that the access to system bus 120 is permitted.

In response to reception of this access signal ACES formed of the system bus use permission, processor 10 requests interface circuit 23 to read information stored at an address 0. In response to the request from processor 10, interface circuit 23 reads out of external memory 140, via interface 80 and system bus 120, the information (instruction) stored at address 0 decoded by decoder 60. Interface circuit 23 outputs the read information (instruction) to processor 10. Processor 10 then requests interface circuit 23 to read data stored in memory 50, based on the information (instruction) received from interface circuit 23.

In response to the request from processor 10, interface circuit 23 outputs transaction signal TRSK, requesting data reading from memory 50, to memory interface 40 via system bus 120. Upon receipt of a signal permitting the data reading from memory interface 40, interface circuit 23 outputs an address on memory 50 where the data is stored to memory interface 40, and receives the data read out of memory 50 via system bus 120. Interface circuit 23 then outputs the received read data as input data DA-IN to processor 10.

In processor 10, after timing T6, multiplexer 11 selects and outputs the input data DA-IN to flip-flop 12, based on enable signal EN of an H level. Flip-flop 12 latches input data DA-IN in synchronization with intermittent clock GCLK, and outputs output data DA-OUT. Thus, data is updated in processor 10.

Here, multiplexer 11 selects the input data DA-IN in synchronization with enable signal EN of an H level. Flip-flop 12 latches the data from multiplexer 11 in synchronization with intermittent clock GCLK, and outputs the output data DA-OUT. Thus, in processor 10, it is possible to update exclusively the data requiring supply of a clock having continuous cycles. It is also possible to update solely necessary data when a clock that is turned on only during the time period synchronized with enable signal EN of an H level (i.e., the intermittent clock) is supplied.

The reading of data and others from memory 50 and external memory 140 after the use of system bus 120 is permitted has been described above. The writing of data and others to those memories after permitted to use system bus 120 is performed in the similar manner.

As explained above, since it is unnecessary to make processor 10 operate from when it issues a request for use of system bus 120 until the use thereof is permitted (i.e., during the time period in which processor 10 waits for the access to system bus 120), interface 20 outputs to processor 10 intermittent clock GCLK with the clock component corresponding to the relevant time period being deleted therefrom. In other words, interface 20 stops the clock supply to processor 10 from when a request for use of system bus 120 is made until the use is permitted. This allows reduction of power consumption of semiconductor device 100. In addition, since the intermittent clock is generated by deleting the clock component, the clock supply to processor 10 can be controlled in a unit of clock cycle.

The main idea of the present invention is to generate and output to processor 10 the intermittent clock GCLK with the clock component of clock CLK corresponding to the time period in which processor 10 is in a non-operational state being deleted therefrom, such that the clock supply to processor 10 is stopped while it does not need to operate. Activation signal generating circuit 22, latch circuit 24 and AND gate 25 that cooperate to generate intermittent clock GCLK constitute a “clock supply circuit”.

Processor 10 outputs the system bus access request to interface circuit 23, and in response thereto, interface circuit 23 outputs bus-use request signal BSAK switching from an L level to an H level at timing T1 to arbiter 70 via system bus 120, and also outputs reset signal RST having the same logical level as bus-use request signal BSAK to activation signal generating circuit 22. Interface circuit 23 determines, upon the output of bus-use request signal BSAK switching from an L level to an H level at timing T1, that processor 10 has entered the waiting state for the access to system bus 120. Activation signal generating circuit 22 generates, based on reset signal RST, enable signal EN that switches from an H level to an L level at timing T2. AND gate 25, based on latch signal ENLTH being the latched version of enable signal EN and switching from an H level to an L level at timing T3, starts deletion of the clock component at timing T3. Accordingly, the event that the clock supply circuit formed of activation signal generating circuit 22, latch circuit 24 and AND gate 25 starts deletion of the clock component at timing T3 corresponds to the event that it stops the clock supply to processor 10 as interface circuit 23 determines that processor 10 has entered the waiting state for the access to system bus 120.

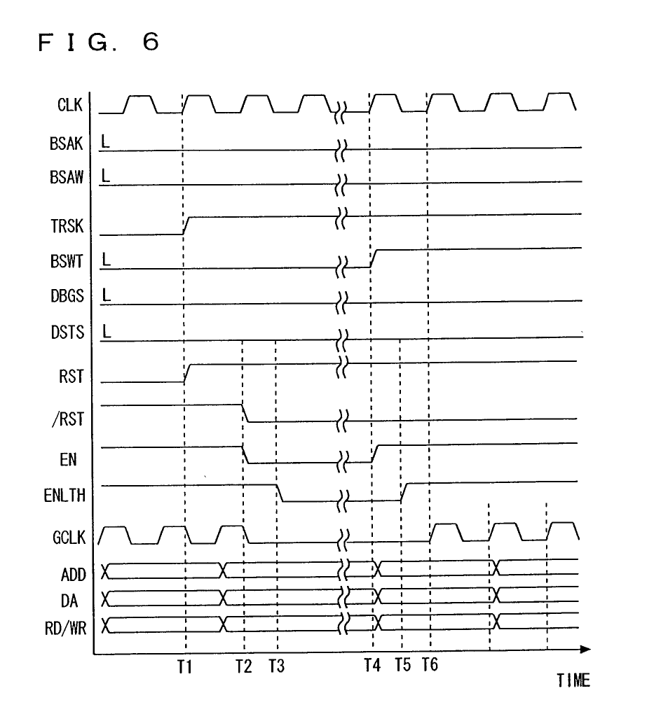

Referring to FIG. 6, the operation for starting writing/reading of data or the like with respect to memory 50 (or external memory 140) will be described. First, processor 10 requests interface circuit 23 to write/read data or the like to/from memory 50 (or external memory 140).

In response to the request from processor 10, interface circuit 23 outputs transaction signal TRSK requesting writing data to or reading data from memory 50 (or external memory 140) to memory interface 40 (or interface 80) via system bus 120. More specifically, interface circuit 23 outputs, to memory interface 40 (or interface 80) via system bus 120, transaction signal TRSK that switches from an L level to an H level at timing T1. Interface circuit 23 also outputs reset signal RST having the same logical level as transaction signal TRSK to activation signal generating circuit 22.

Memory interface 40 (or interface 80) determines whether data writing/reading with respect to memory 50 (or external memory 140) is possible. If so, it outputs a signal indicating that the data writing/reading with respect to memory 50 (or external memory 140) is possible, to activation signal generating circuit 22 and interface circuit 23 via system bus 120. More specifically, memory interface 40 (or interface 80) outputs, to activation signal generating circuit 22 and interface circuit 23 via system bus 120, bus-wait signal BSWT that switches from an L level to an H level at timing T4. Here, bus-use permit signal BSAW, debug start signal DBGS and interrupt signal DSTS are all at an L level.

In activation signal generating circuit 22, inverter 221 inverts reset signal RST and outputs inverse signal/RST switching from an H level to an L level at timing T2, to OR gate 222. OR gate 222 performs an OR operation of bus-use permit signal BSAW, bus-wait signal BSWT, debug start signal DBGS, interrupt signal DSTS and inverse signal/RST, and outputs enable signal EN switching from an H level to an L level at timing T2 and switching from an L level to an H level at timing T4, to latch circuit 24 and multiplexer 11 of processor 10.

Latch circuit 24 latches enable signal EN by a half cycle of clock CLK, and outputs the resultant latch signal ENLTH to AND gate 25. AND gate 25 performs an AND operation of latch signal ENLTH and clock CLK, and outputs intermittent clock GCLK to flip-flop 12 of processor 10. Thereafter, the data writing/reading with respect to memory 50 (or external memory 140) is performed in the above-described manner.

As a result, interface 20 outputs to flip-flop 12 the intermittent clock GCLK with the clock component corresponding to the time period from timing T3 to timing T6 being deleted, to stop the clock supply to processor 10 during the time period from when the data writing/reading with respect to memory 50 (or external memory 140) is requested to memory interface 40 (or interface 80) until the same is permitted.

Accordingly, the clock supply to processor 10 is stopped while processor 10 is in a non-operational state, from when the data writing/reading with respect to memory 50 (or external memory 140) is requested until it is permitted, or, during the time period in which processor 10 waits for the access to system bus 120. As a result, reduction of power consumption in semiconductor device 100 is enabled.

Processor 10 makes a request to interface circuit 23 for writing/reading of data or the like with respect to memory 50 (or external memory 140). In response to this request, interface circuit 23 outputs transaction signal TRSK switching from an L level to an H level at timing T1, to memory interface 40 (or interface 80) via system bus 120, and also outputs reset signal RST having the same logical level as transaction signal TRSK, to activation signal generating circuit 22. Here, interface circuit 23 determines, based on the output of the transaction signal TRSK, that processor 10 has entered the access-waiting state to system bus 120. Activation signal generating circuit 22 generates, based on reset signal RST, enable signal EN switching from an H level to an L level at timing T2. AND gate 25 starts deletion of the clock component at timing T3, based on latch signal ENLTH, being the latched version of enable signal EN and switching from an H level to an L level at timing T3. Accordingly, that the clock supply circuit made of activation signal generating circuit 22, latch circuit 24 and AND gate 25 starts the deletion of the clock component at timing T3 corresponds to the fact that the clock supply circuit stops the clock supply to processor 10 as interface circuit 23 determines that processor 10 has entered the access-waiting state to system bus 120.

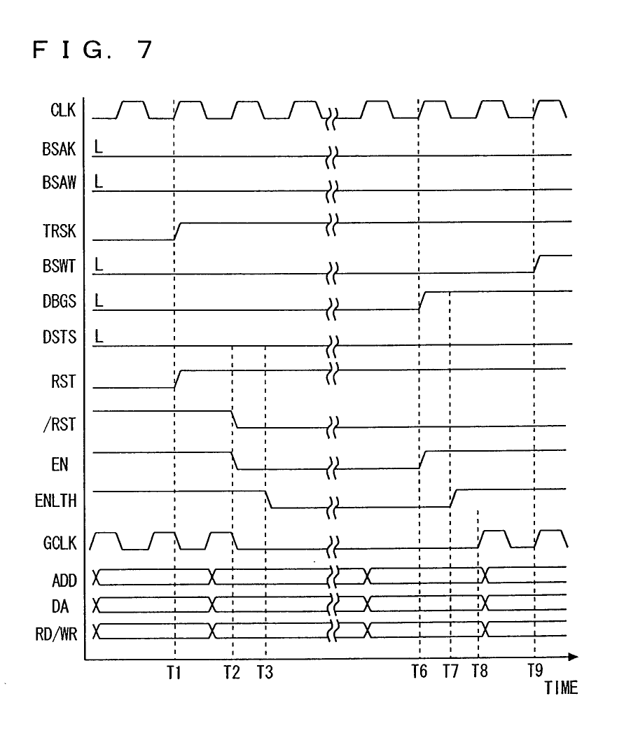

Referring to FIG. 7, the operation in the case of starting writing/reading of data or the like to/from memory 50 (or external memory 140) wherein debugging is requested before memory interface 40 (or interface 80) permits the data writing/reading will be described. In FIG. 7, it is assumed that the data writing/reading with respect to memory 50 (or external memory 140) is requested at timing T1 and permitted at timing T9.

As described above with reference to FIG. 6, interface 20 outputs transaction signal TRSK switching from an L level to an H level at timing T1, to memory interface 40 (or interface 80) via system bus 120. Thereafter, it receives from debug interface 110 debug start signal DBGS that switches from an L level to an H level at timing T6.

OR gate 222 of activation signal generating circuit 22 performs an OR operation of bus-use permit signal BSAW, bus-wait signal BSWT, debug start signal DBGS, interrupt signal DSTS and inverse signal /RST, and outputs enable signal EN switching from an H level to an L level at timing T2 and switching from an L level to an H level at timing T6, to latch circuit 24 and multiplexer 11 of processor 10.

Latch circuit 24 latches enable signal EN by a half cycle of clock CLK and outputs latch signal ENLTH to AND gate 25. AND gate 25 performs an AND operation of latch signal ENLTH and clock CLK, and outputs intermittent clock GCLK with the clock component corresponding to the time period from timing T3 to timing T7 being deleted, to flip-flop 12 of processor 10.

When a debug request is input, processor 10 needs to operate. Thus, interface 20 outputs to multiplexer 11 enable signal EN switching from an L level to an H level at timing T6 in response to debug start signal DBGS of an H level, and also outputs to flip-flop 12 intermittent clock GCLK for the clock supply to processor 10 after timing T7.

Accordingly, processor 10 is able to perform debugging from timing T8, prior to the timing T9 at which the data writing/reading with respect to memory 50 (or external memory 140) is permitted.

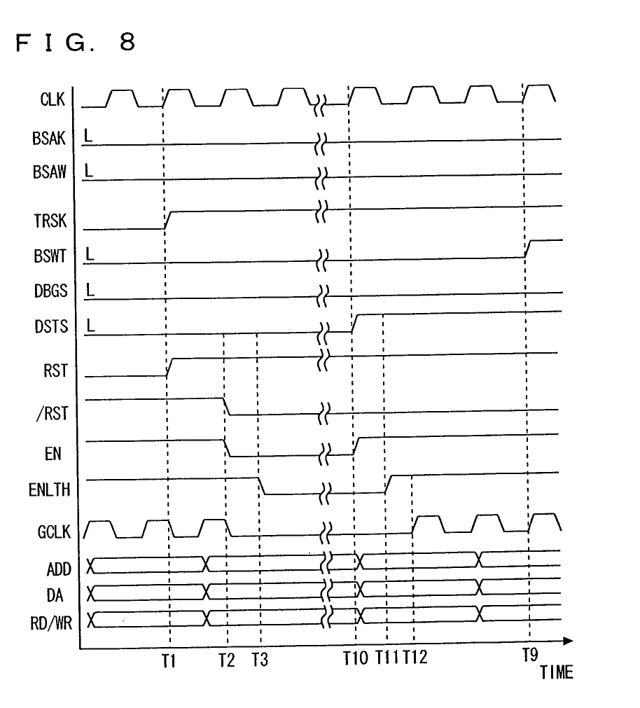

Referring to FIG. 8, the operation in the case of starting writing/reading of data or the like to/from memory 50 (or external memory 140) wherein interruption is requested before memory interface 40 (or interface 80) permits the data writing/reading will be described. In FIG. 8, it is assumed that the data writing/reading with respect to memory 50 (or external memory 140) is requested at timing T1 and permitted at timing T9.

As described above with respect to FIG. 6, interface 20 outputs transaction signal TRSK switching from an L level to an H level at timing T1, to memory interface 40 (or interface 80) via system bus 120. It then receives, from controller 90, interrupt signal DSTS that switches from an L level to an H level at timing T10.

OR gate 222 of activation signal generating circuit 22 performs an OR operation of bus-use permit signal BSAW, bus-wait signal BSWT, debug start signal DBGS, interrupt signal DSTS and inverse signal/RST, and outputs enable signal EN switching from an H level to an L level at timing T2 and switching from an L level to an H level at timing T10, to latch circuit 24 and multiplexer 11 of processor 10.

Latch circuit 24 latches enable signal EN by a half cycle of clock CLK, and outputs latch signal ENLTH to AND gate 25. AND gate 25 performs an AND operation of latch signal ENLTH and clock CLK, and outputs intermittent clock GCLK with the clock component corresponding to the time period from timing T3 to timing T11 being deleted, to flip-flop 12 of processor 10.

When an interrupt request is input, processor 10 needs to operate. Thus, interface 20 outputs to multiplexer 11 enable signal EN switching from an L level to an H level at timing T10 in response to interrupt signal DSTS of an H level, and also outputs to flip-flop 12 intermittent clock GCLK for the clock supply to processor 10 after timing T11.

Accordingly, processor 10 is able to start at timing T12 the operation responding to the interrupt request, before the data writing/reading with respect to memory 50 (or external memory 140) is permitted at timing T9.

In interface 20, it is also possible to forcibly stop the clock supply to processor 10 using clock control register 21. Specifically, clock control register 21 receives a stop signal STP from the outside of semiconductor device 100, and in response thereto, stops the supply of clock CLK to activation signal generating circuit 22 and interface circuit 23. In this case, OR gate 222 in activation signal generating circuit 22 is not driven, so that enable signal EN is not sent to multiplexer 11 or latch circuit 24. As a result, the clock supply to processor 10 is stopped.

Thus, in semiconductor device 100, the clock supply to processor 10 can be stopped forcibly with a signal externally supplied.

According to the first embodiment, the semiconductor device is provided with a clock supply circuit that stops clock supply to a processor during a time period in which the processor is in a non-operational state. Thus, power consumption of the semiconductor device can be reduced.

Further, the clock supply circuit generates, in synchronization with a clock, an intermittent clock with the clock component corresponding to the time period during which the processor is in the non-operational state being deleted therefrom, and outputs the generated intermittent clock to the processor. Accordingly, the clock supply to the processor can be controlled on a clock cycle basis.

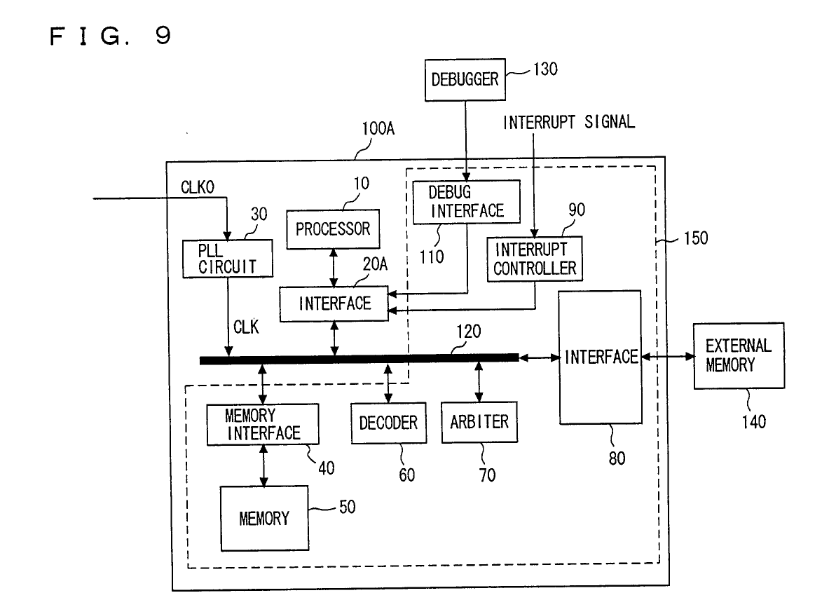

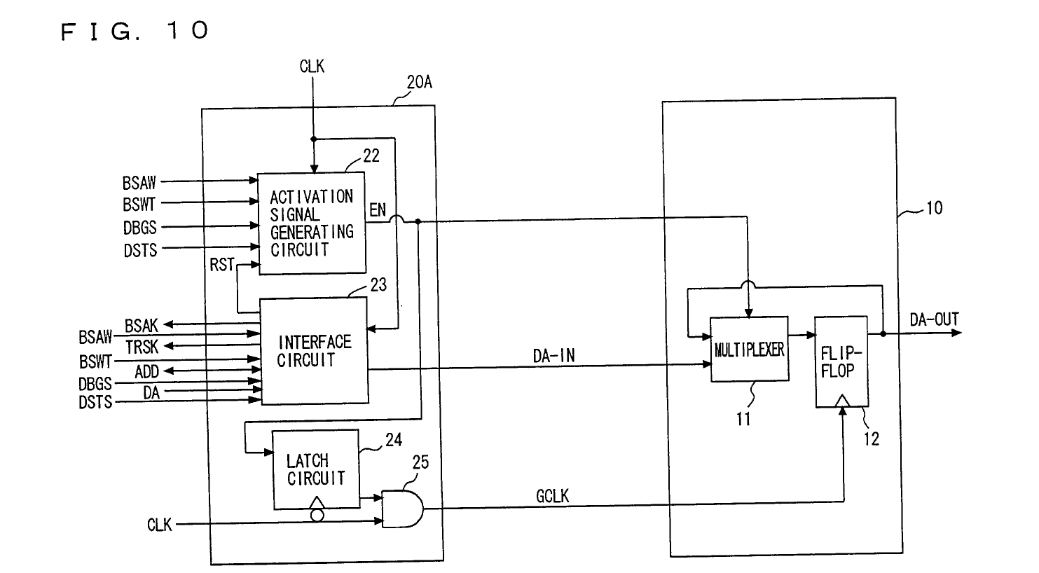

Second Embodiment Referring to FIG. 9, the semiconductor device 100A according to the second embodiment is identical to semiconductor device 100 of the first embodiment, except that it has an interface 20A as a substitute for interface 20 of semiconductor device 100.

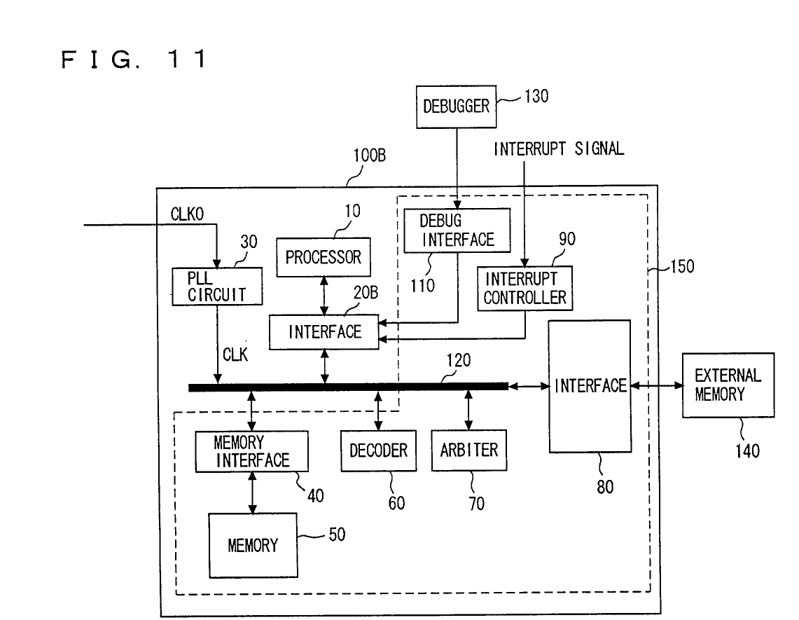

Referring to FIG. 10, interface 20A differs from interface 20 only in that clock control register 21 as in interface 20 is unprovided.

Interface 20A stops the clock supply to processor 10 during the time period where processor 10 is in a non-operational state, according to the operation described above with reference to FIGS. 5-8. Since interface 20A does not include clock control register 21 as in interface 20, the power consumption can further be reduced in semiconductor device 100A than in semiconductor device 100. Otherwise, the second embodiment is identical to the first embodiment.

According to the second embodiment, the semiconductor device is provided with a clock supply circuit that stops clock supply to a processor while it is in a non-operational state, and is unprovided with a clock control register controlling the clock supply by software. Therefore, the power consumption of the semiconductor device can further be reduced.

Third Embodiment

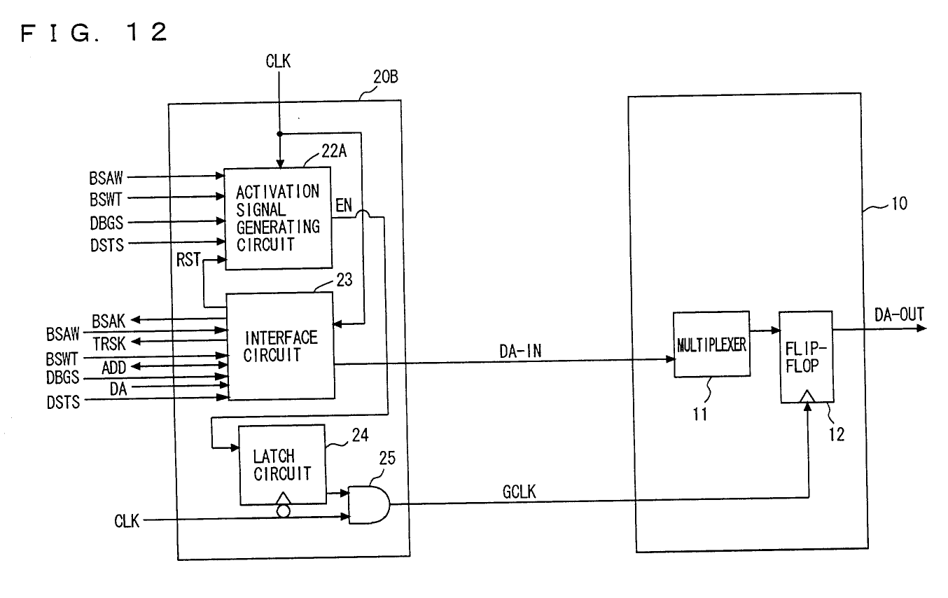

Referring to FIG. 11, the semiconductor device 100B according to the third embodiment is identical to the semiconductor device 100A of the second embodiment, except that interface 20A of semiconductor device 100A is replaced with an interface 20B.

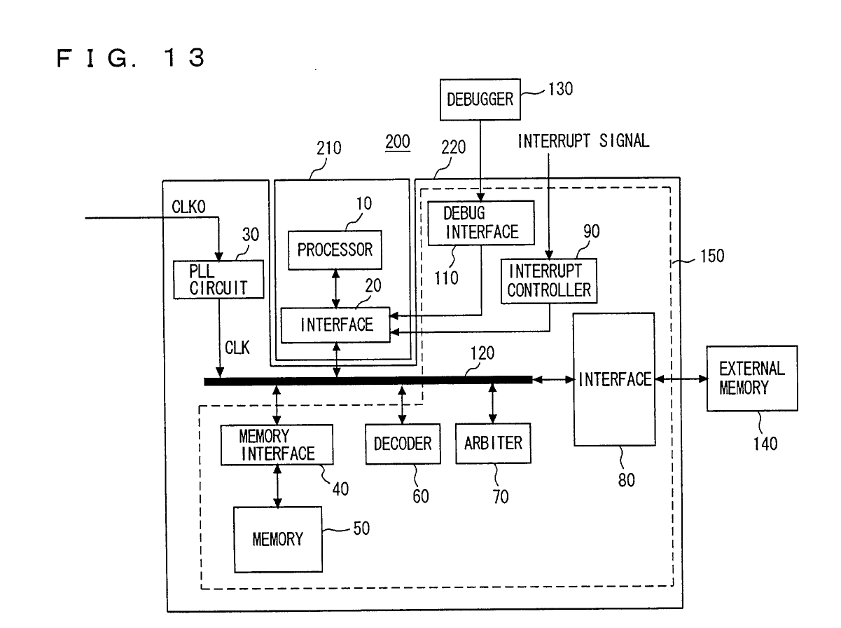

Referring to FIG. 12, interface 20B is identical to interface 20A, except that activation signal generating circuit 22 of interface 20A is replaced with an activation signal generating circuit 22A.

Activation signal generating circuit 22A differs from activation signal generating circuit 22 in that, although formed of inverter 221 and OR gate 222 as in activation signal generating circuit 22 (see FIG. 4), it does not output the generated enable signal EN to multiplexer 11 of processor 10. Interface 20B generates intermittent clock GCLK according to the operations explained above with reference to FIGS. 5-8, like interfaces 20 and 20A, and outputs the generated intermittent clock GCLK to flip-flop 12 of processor 10.

Multiplexer 11 receives only the input data DA-IN from interface circuit 23; it does not receive the output data DA-OUT from flip-flop 12. Thus, upon receipt of input data DA-IN, multiplexer 11 outputs the input data DA-IN to flip-flop 12. Flip-flop 12, in synchronization with intermittent clock GCLK from interface 20B, latches input data DA-IN and outputs output data DA-OUT.

In the processor 10 shown in the first and second embodiments, the data updating has been controlled by enable signal EN and intermittent clock GCLK from interface 20, 20A. In the processor 10 of the third embodiment, however, the data updating is controlled only by intermittent clock GCLK. That is, in the third embodiment, while flip-flop 12 constantly receives input data DA-IN, it latches input data DA-IN only during the time period where the clock component exists in intermittent clock GCLK, and outputs output data DA-OUT. Thus, in the third embodiment, multiplexer 11 and flip-flop 12 can update data only while continuous clock components exist. Otherwise, the third embodiment is identical to the first embodiment.

According to the third embodiment, the semiconductor device is provided with a clock supply circuit that stops clock supply to a processor while it is in a non-operational state. A select signal for selecting input data or output data in the processor is not provided to the processor. Accordingly, the power consumption in the semiconductor device can further be reduced.

Fourth Embodiment

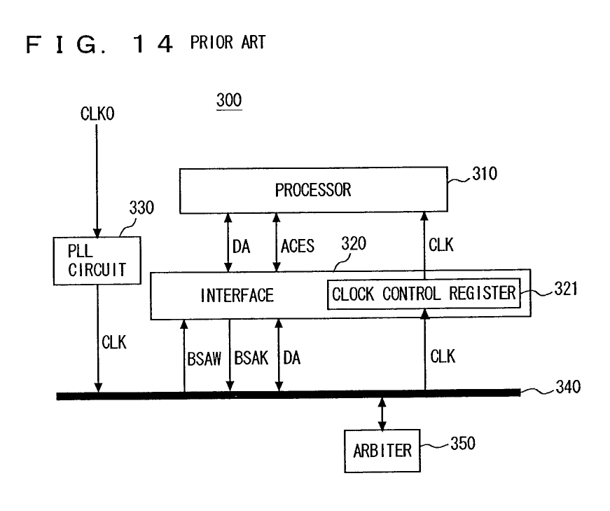

Referring to FIG. 13, the semiconductor device 200 according to the fourth embodiment is provided with a semiconductor device 210 and a semiconductor device 220. Semiconductor device 210 includes processor 10 and interface 20. Semiconductor device 220 includes PLL circuit 30, memory interface 40, memory 50, decoder 60, arbiter 70, interface 80, interrupt controller 90, debug interface 110, and system bus 120.

Processor 10, interfaces 20, 80, PLL circuit 30, memory interface 40, memory 50, decoder 60, arbiter 70, interrupt controller 90, debug interface 110, debugger 130, and external memory 140 are as described above.

Semiconductor device 200 is formed of two semiconductor devices 210 and 220, and semiconductor device 210 includes processor 10 that performs data processing, and interface 20 that controls transmission of data and others between processor 10 and system bus 120.

Semiconductor device 220 includes memory 50 that stores data, memory interface 40 that controls access to memory 50, interface 80 that controls access to external memory 140, and others. The components included in semiconductor device 220 are for input/output of data and signals necessary for the data processing in processor 10.

Accordingly, it can be said that semiconductor device 210 provided with main control circuitry and semiconductor device 220 provided with auxiliary control circuitry constitute the semiconductor device 200.

The operation in semiconductor device 200 for stopping the clock supply to processor 10 is identical to that in semiconductor device 100.

In semiconductor device 200, interface 20 of semiconductor device 210 may be replaced with interface 20A or 20B. In this case, the operation in semiconductor device 200 for stopping the clock supply to processor 10 is the same as in the corresponding semiconductor device 100A or 100B.

In the fourth embodiment, semiconductor device 210 provided with the main control circuitry, including processor 10 that performs data processing and interface 20 that controls the clock supply to processor 10, is combined with semiconductor device 220 provided with the auxiliary control circuitry, so that a semiconductor device that stops clock supply to processor 10 during a time period where processor 10 is in a non-operational state, and thus consumes less power, can be realized. Otherwise, the fourth embodiment is the same as the first to third embodiments.

According to the fourth embodiment, the semiconductor device is provided with a semiconductor device having a processor that performs data processing and an interface that controls clock supply to the processor being fabricated on one and the same semiconductor substrate. By combining this semiconductor device provided with the main control circuitry with each of other semiconductor devices provided with auxiliary control circuitry having various functions, power consumption in the respective, combined semiconductor devices can be reduced.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A semiconductor device performing data processing in synchronization with a clock, comprising:
a processing circuit reading the data from a system bus in response to an operation command and performing said data processing in synchronization with said clock;
an interface circuit controlling signal and data transmission between said system bus and said processing circuit; and
a clock supply circuit providing said clock to said processing circuit,
said clock supply circuit stopping provision of said clock to said processing circuit on a clock cycle basis when said interface circuit determines that said processing circuit has entered a waiting state for access to said system bus.

2. The semiconductor device according to claim 1, wherein said clock supply circuit generates an intermittent clock by deleting from said clock at least one clock component corresponding to a time period in which said processing circuit is in said waiting state, and provides the intermittent clock to said processing circuit.

3. The semiconductor device according to claim 2, further comprising:
a slave portion including a memory storing the data input via said system bus and outputting the data to said system bus in response to a data read request; and
an interrupt controller that receives an interrupt signal externally supplied and outputs the interrupt signal to said interface circuit and said clock supply circuit, and
said clock supply circuit, upon reception of said interrupt signal at a first timing, generates said intermittent clock by deleting from said clock the at least one clock component corresponding to at least a time period from a second timing to said first timing, said second timing being a timing at which said interface circuit outputs a request signal to said slave portion via said system bus.

4. The semiconductor device according to claim 2, further comprising:
a slave portion including a memory storing the data input via said system bus and outputting the data to said system bus in response to a data read request; and
a debug interface that receives an externally supplied debug start signal for start of debugging and outputs said debug start signal to said interface circuit and said clock supply circuit, and
said clock supply circuit, upon reception of said debug start signal at a first timing, generates said intermittent clock by deleting from said clock the at least one clock component corresponding to the time period from a second timing to said first timing, said second timing being a timing at which said interface circuit outputs a request signal to said slave portion via said system bus.

5. The semiconductor device according to claim 2, further comprising a slave portion including a memory storing the data input via said system bus and outputting the data to said system bus in response to a data read request;
wherein said clock supply circuit generates said intermittent clock by deleting from said clock the at least one clock component corresponding to the time period from a first timing at which said interface circuit outputs a request signal to said slave portion via said system bus to a second timing at which said interface circuit receives a permit signal with respect to said request signal from said slave portion via said system bus.

6. The semiconductor device according to claim 5, wherein
said slave portion further includes an arbiter that determines availability of said system bus upon reception of a request signal for use of said system bus output from said interface circuit, and outputs a permit signal for the use of said system bus when said system bus is available, and
said clock supply circuit generates said intermittent clock by deleting from said clock the at least one clock component corresponding to the time period from said first timing at which said interface circuit outputs said request signal to said arbiter via said system bus to said second timing at which said interface circuit receives said permit signal from said arbiter via said system bus.

7. The semiconductor device according to claim 5, wherein
said slave portion further includes a memory interface that controls signal and data transmission between said system bus and said memory, and
said clock supply circuit generates said intermittent clock by deleting from said clock the at least one clock component corresponding to the time period from said first timing at which said interface circuit outputs a request signal for data read/write with respect to said memory to said memory interface via said system bus to said second timing at which said interface circuit receives a permit signal permitting access to said memory from said memory interface via said system bus.

8. The semiconductor device according to claim 5, further comprising a select signal generating circuit that generates, based on said permit signal from said slave portion, a select signal used for data selection when updating the data in said processing circuit, and outputs the select signal to said processing circuit, wherein
said clock supply circuit generates said intermittent clock by an AND operation of said select signal and said clock.

9. The semiconductor device according to claim 1, further comprising a clock control register controlling supply of said clock to said clock supply circuit, wherein
said clock control register stops the supply of said clock to said clock supply circuit in response to a request for stoppage of said clock.
